(19) United States
(12) Patent Application Publication
(10) Pub. No.: US 2010/0171918 A1
(43) Pub. Date: Jul. 8, 2010

(54) LIQUID CRYSTAL DISPLAY DEVICE AND MANUFACTURING METHOD THEREOF

(75) Inventors: Kazunari SAITOU, Mobara (JP); Katsumi Kobara, Mobara (JP); Masaharu Itakura, Shirako (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/649,442

(22) Filed: Dec. 30, 2009

(30) Foreign Application Priority Data
Jan. 7, 2009 (JP) 2009-001606

(51) Int. Cl. G02F 1/1345; G02F 1/13

(52) U.S. Cl. 349/149; 349/187

(57) ABSTRACT

In a miniaturized liquid crystal display device, a thickness of the liquid crystal display device is decreased and the occurrence of cracks is prevented. A portion of a TFT substrate to which a lower polarizer is adhered has a small thickness, and a periphery of the TFT substrate including a terminal portion has a large thickness. A portion of a counter substrate to which an upper polarizer is adhered has a small thickness, and a periphery of the counter substrate except for one side which forms a U shape has a large thickness. Accordingly, in adhering the upper polarizer to the counter substrate, it is possible to decrease a possibility that a foreign material is entangled. By applying chemical polishing to edge portions of the TFT substrate and edge portions of the counter substrate, the edge portions are rounded and hence, the probability of occurrence of cracks caused by an impact or the like from the outside can be decreased.

### CLAIM OF PRIORITY

The present application claims priority from Japanese application serial No. 2009-1606, filed on Jan. 7, 2009, the content of which is hereby incorporated by reference into this application.

### BACKGROUND OF THE INVENTION

1. Field of the Invention

The present invention relates to a display device, and more particularly to a liquid crystal display device which can decrease a thickness thereof and can prevent chipping of an edge portion of a substrate.

2. Description of the Related Art

A liquid crystal display device includes a TFT substrate on which pixel electrodes, thin film transistors (TFT) and the like are formed in a matrix array, a counter substrate which faces the TFT substrate in an opposed manner and mounts color filters or the like thereon at positions corresponding to the pixel electrodes on the TFT substrate, and liquid crystal which is sandwiched between the TFT substrate and the counter substrate. In the liquid crystal display device, an image is formed by controlling optical transmissivity of liquid crystal molecules for every pixel.

The liquid crystal display device is flat and light-weighted and hence, the use of the liquid crystal display device has been spreading to various fields. A miniaturized liquid crystal display device has been popularly used in a mobile phone, a DSC (Digital Still Camera) or the like. In the mobile phone, the DSC (Digital Still Camera) or the like, there exists a strong demand for the decrease of thickness of the liquid crystal display device in order to decrease a thickness of a product per se.

In an attempt to satisfy such a demand, there has been proposed a technique where an outer side of a TFT substrate and an outer side of a counter substrate are polished after combining the TFT substrate and the counter substrate thus decreasing the thickness of the liquid crystal display device. Further, efforts have been also made so as to decrease as much as possible thicknesses of parts which constitute a backlight.

With respect to the types of liquid crystal display device, there have been known a transmissive liquid crystal display device which arranges a backlight on a back surface thereof, and a reflective liquid crystal display device which forms an image by making use of the reflection of an ambient light. JP-A-5-249423 (hereinafter referred to as patent document 1) discloses a reflective liquid crystal display device having the constitution which can decrease the influence of reflection of an ambient light which is generated simultaneously when the ambient light passes glass.

In patent document 1, there is disclosed a technique where a polarizer is adhered to a front-surface substrate and a back-surface substrate respectively and, further, particularly for decreasing a deviation of a path of the reflection light, a thickness of a portion of the back-surface substrate to which the polarizer is adhered is decreased by etching. Here, to prevent the liquid crystal display panel from lowering strength thereof as a whole, the back-surface glass substrate is etched except for a peripheral portion thereof and a plate thickness of the peripheral portion is not decreased.

### SUMMARY OF THE INVENTION

In the constitution of the reflective liquid crystal display device disclosed in patent document 1, for decreasing the deviation of the reflection light of the ambient light, the thickness of only the portion of the glass substrate to which the polarizer is adhered is decreased except for the peripheral portion of the glass substrate. In such a constitution of the display device disclosed in patent document 1, a recessed portion is formed in the portion of the glass substrate to which the polarizer is adhered. Accordingly, when a foreign material is present in the recessed portion, it is difficult to remove the foreign material. When the polarizer is adhered to the glass substrate in a state where the foreign material is present in the recessed portion, portions where the foreign material is present bring about screen defects thus lowering a yield rate of the reflective liquid crystal display device. The probability that the foreign material is present in the recessed portion is large on a counter substrate side of the liquid crystal display device which constitutes an upper side of the liquid crystal display device.

Further, in the technique disclosed in patent document 1, at the time of dividing a mother substrate into individual liquid crystal display panels, a plate thickness of divided portions of the liquid crystal display panels is not decreased. In dividing the mother substrate into individual liquid crystal display panels, a scribe is formed on division lines using a diamond cutter or the like and, thereafter, a stress is applied to the glass substrate thus breaking the glass substrate. In such a dividing method, there may be a possibility that minute cracks occur in a portion of the mother substrate on the division line (scribe region), and, minute cracks progress in the inside of the glass substrate thus breaking the glass substrate. Particularly, in the constitution of the glass substrate where a plate thickness of the inner side of the glass substrate is set smaller than a plate thickness of the periphery of the glass substrate, there exists a large possibility that cracks caused by minute cracks occur in the glass substrate.

It is an object of the present invention to provide a technique which can prevent breaking of a glass substrate caused by minute cracks in a scribe region of a liquid crystal display panel while decreasing a plate thickness of the whole liquid crystal display panel after adhesion of the polarizer to the liquid crystal display panel.

The present invention has been made to overcome the above-mentioned drawbacks. To explain the specific constitution of the present invention, they are as follows.

(1) According to one aspect of the present invention, there is provided a display device which includes: a TFT substrate on which pixels each of which includes a pixel electrode and a thin film transistor are formed in a matrix array; a counter substrate which is arranged to face the TFT substrate in an opposed manner with a predetermined distance defined therebetween; and liquid crystal which is sandwiched between the TFT substrate and the counter substrate, the TFT substrate being formed larger than counter substrate in size, and a terminal portion being formed on a portion of the TFT substrate where the TFT substrate is formed larger than the counter substrate, wherein a periphery of the counter substrate is formed of three sides having a large thickness and one side having a thickness smaller than the thickness of said three sides, said one side corresponding to the terminal portion formed on the TFT substrate, a periphery of the TFT substrate is formed of four sides having a large thickness and one of said four sides corresponds to the terminal portion, and edge portions of the TFT substrate and edge portions of the counter substrate are polished by chemical polishing.

(2) According to another aspect of the present invention, there is provided a method of manufacturing a liquid crystal display device in which a liquid crystal display device are manufactured by dividing a mother substrate which is constituted of a mother TFT substrate on which a plurality of TFT substrates are formed and a mother counter substrate on which a plurality of counter substrates are formed into individual liquid crystal cells, wherein a TFT substrate mask having a window is adhered to the mother TFT substrate for every TFT substrate, and a space is defined between the TFT substrate mask and the TFT substrate mask, a counter substrate mask having a window is adhered to the mother counter substrate for every counter substrate, and a space is defined between the counter substrate mask and the counter substrate mask, the TFT substrate masks are adhered to the mother TFT substrate, and the counter substrate masks are adhered to the mother counter substrate, and portions of the mother TFT substrate and portions of the mother counter substrate which are not covered with the TFT substrate mask and the counter substrate mask are polished by chemical polishing.

(3) According to still another aspect of the present invention, there is provided a method of manufacturing a liquid crystal display device in which a liquid crystal display device are manufactured by dividing a mother substrate which is constituted of a mother TFT substrate on which a plurality of TFT substrates are formed and a mother counter substrate on which a plurality of counter substrates are formed into individual liquid crystal cells, wherein a mother TFT substrate mask on which a first region and a second region are formed is adhered to the mother TFT substrate for every said TFT substrate in a state where the first region includes a center portion having a plurality of holes in a predetermined area and a peripheral portion having no holes, and a plurality of holes are formed in the second region between the first region corresponding to the TFT substrate and the first region corresponding to the TFT substrate, a mother counter substrate mask on which a third region and a fourth region are formed is adhered to the mother counter substrate for every counter substrate in a state where the third region includes a center portion having a plurality of holes in a predetermined area and a peripheral portion having no holes, and a plurality of holes are formed in the fourth region between the third region corresponding to the counter substrate and the third region corresponding to the counter substrate, and the portions of the mother TFT substrate corresponding to the portions of the mother TFT substrate mask where the plurality of holes are formed and the portions of the mother counter substrate corresponding to the portions of the mother counter substrate mask where the plurality of holes are formed are polished by chemical polishing of the mother substrate.

(4) According to a further object of the present invention, there is provided a method of manufacturing a liquid crystal display device in which a liquid crystal display device are manufactured by dividing a mother substrate which is constituted of a mother TFT substrate on which a plurality of TFT substrates are formed and a mother counter substrate on which a plurality of counter substrates are formed into individual liquid crystal cells, wherein a mother TFT substrate mask on which a first region and a second region are formed is adhered to the mother TFT substrate for every TFT substrate in a state where the first region includes a window portion having a predetermined area and a peripheral portion around the window portion, and a plurality of holes are formed in the second region between the first region corresponding to the TFT substrate and the first region corresponding to the TFT substrate, a mother counter substrate mask on which a third region and a fourth region are formed is adhered to the mother counter substrate for every counter substrate in a state where the third region includes a window portion having a predetermined area and a peripheral portion around the window portion, and a plurality of holes are formed in the fourth region between the third region corresponding to the counter substrate and the third region corresponding to the counter substrate, and the portions of the mother TFT substrate corresponding to the portions of the mother TFT substrate mask where the window portions and the plurality of holes are formed and the portions of the mother counter substrate corresponding to the portions of the mother counter substrate mask where the window portions and the plurality of holes are formed are polished by chemical polishing of the mother substrate.

According to the present invention, in the TFT substrate, the portions of the TFT substrate to which the lower polarizer is adhered are made thin by chemical polishing while allowing the peripheral portions of the TFT substrate to maintain the large thickness. Further, three peripheral sides of the counter substrate are formed into the U-shaped thick portion and one peripheral portion of the counter substrate which corresponds to the terminal portion and the portion of the counter substrate to which the upper polarizer is adhered are made thin by chemical polishing. Accordingly, it is possible to decrease the thickness of the liquid crystal display device after the polarizers are adhered to the TFT substrate and the counter substrate. Further, one side of the counter substrate is made thin and hence, the probability that a foreign material is present at the time of adhering the upper polarizer to the counter substrate can be decreased.

Further, according to the present invention, the edge portions of the liquid crystal cell which is separated from the mother substrate forms the chemically etched surfaces and are rounded and hence, it is possible to prevent the occurrence of cracks or the like caused by an impact in the edge portions.

### BRIEF DESCRIPTION OF THE DRAWINGS

FIG. 1A to FIG. 1C are views showing an example of a liquid crystal display device to which the present invention is applied;

FIG. 2A and FIG. 2B are views showing an example of a mother substrate to which the present invention is applied;

FIG. 3 is a view showing an example of a mask in a chemical polishing step of a mother TFT substrate in an embodiment 1;

FIG. 4 is a view showing an example of the mask in the chemical polishing step of a mother counter substrate in the embodiment 1;

FIG. 5A and FIG. 5B are planar schematic views of a TFT substrate and a counter substrate of a liquid crystal cell of the present invention;

FIG. 6A to FIG. 6C are views showing an example of the liquid crystal cell according to the present invention;

FIG. 7 is a view showing an example of a mask for the mother counter substrate of the other liquid crystal cell of the embodiment 1;

FIG. 8 is a view showing an example of the mask for a mother TFT substrate of an embodiment 2; and

FIG. 9 is a view showing an example of the mask for a mother TFT substrate of an embodiment 3.

### DESCRIPTION OF THE PREFERRED EMBODIMENTS

The present invention is explained in detail in conjunction with embodiments hereinafter.

### Embodiment 1

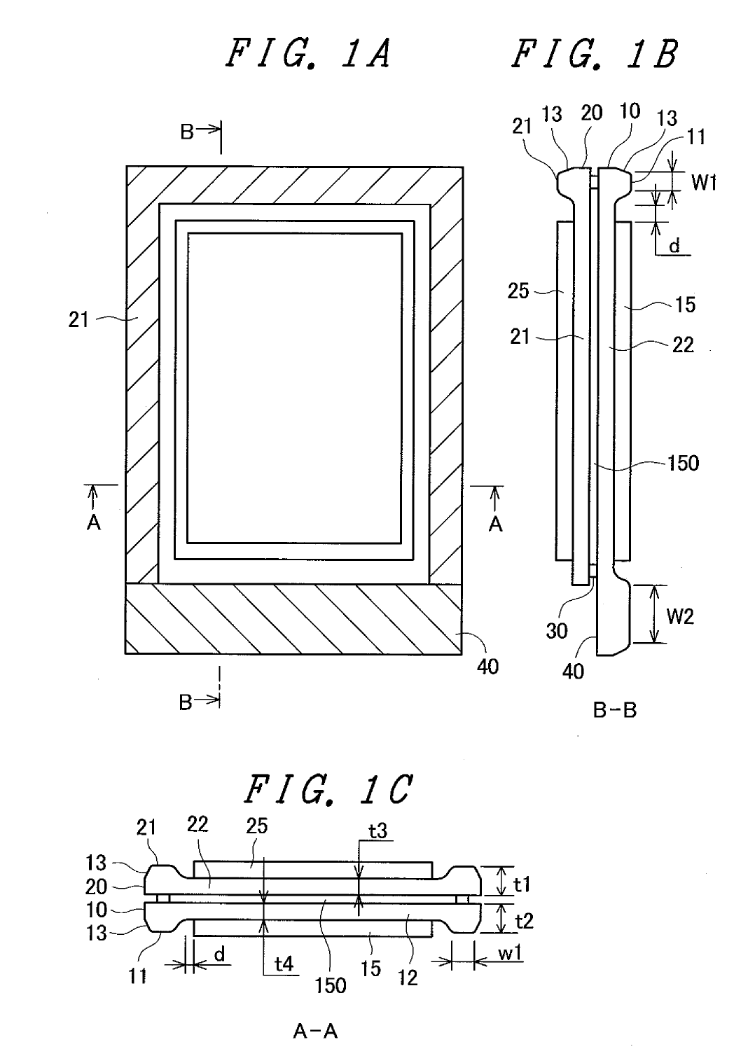

FIG. 1A to FIG. 10 show an example of a liquid crystal display device to which the present invention is applied. FIG. 1A to FIG. 1C shows a case where the liquid crystal display device is used in a mobile phone or the like. FIG. 1A is a plan view of the liquid crystal display device, FIG. 1B is a cross-sectional view of the liquid crystal display device taken along a line B-B in FIG. 1A, and FIG. 10 is a cross-sectional view of the liquid crystal display device taken along a line A-A in FIG. 1A.

In FIG. 1A, a counter substrate 20 is arranged on a TFT substrate 10. The TFT substrate 10 and the counter substrate 20 are adhered to each other by a sealing material 30 shown in FIG. 1B which is formed on peripheries of respective substrates. A liquid crystal layer 150 shown in FIG. 1B is sandwiched between the TFT substrate 10 and the counter substrate 20, and the liquid crystal layer 150 is sealed with the sealing material 30.

In FIG. 1A, a counter-substrate thick portion 21 having a U shape is formed on a periphery of the counter substrate 20. The counter-substrate thick portion is not formed on a terminal-portion-40 side. In FIG. 1A, a counter-substrate thin portion 22 is formed on a most portion of the counter substrate 20 except for a periphery of the counter substrate 20. An upper polarizer 25 is adhered to a portion of the counter substrate 20 which constitutes the thin portion. A display region 90 has an area slightly smaller than an area of the upper polarizer 25.

In FIG. 1A, the TFT substrate 10 is arranged below the counter substrate 20. The TFT substrate 10 is formed larger than the counter substrate 20, and a terminal portion 40 is formed on a portion of the TFT substrate 10 where the TFT substrate 10 is formed larger than the counter substrate 20. On the terminal portion 40, an IC driver not shown in the drawing which includes a scanning signal drive circuit, a video signal drive circuit and the like for driving the liquid crystal display device is arranged. Further, on the terminal portion 40, terminals for supplying a scanning signal, a video signal, electricity and the like to the liquid crystal display device are formed.

The TFT substrate 10 is not described in FIG. 1A except for the terminal portion 40. However, on a back side of the TFT substrate 10, a TFT-substrate thick portion 11 is formed on a periphery of the TFT substrate 10 corresponding to a peripheral portion of the counter substrate 20. Further, with respect to the TFT substrate 10 made of glass, a back-side portion of the TFT substrate 10 corresponding to the terminal portion 40 has a large thickness in the same manner as the TFT-substrate thick portion 11.

FIG. 1B is a cross-sectional view of the liquid crystal display device taken along a line B-B in FIG. 1A. In FIG. 1B, the TFT substrate 10 and the counter substrate 20 face each other in an opposed manner by way of the sealing material 30, and the liquid crystal layer 150 is sandwiched between the TFT substrate 10 and the counter substrate 20. In FIG. 1B, although a counter-substrate thick portion 21 is formed on the periphery of the counter substrate 20, a thick portion is not formed on a terminal portion-40-side peripheral portion of the counter substrate 20. In FIG. 1B, a thickness of the counter-substrate thick portion 21 is set to 0.22 mm, for example, and a thickness of the counter-substrate thin portion 22 is set to 0.1 mm.

In FIG. 1B, the upper polarizer 25 is adhered to the counter-substrate thin portion 22. A thickness of the upper polarizer 25 is set to 0.12 mm, for example. Accordingly, an upper surface of the counter-substrate thick potion 21 and an upper surface of the upper polarizer 25 have the same height.

In FIG. 1B, on the peripheral portion of the TFT substrate 10, the TFT-substrate thick portion 11 is formed corresponding to the peripheral portion of the counter substrate 20. A width of the TFT-substrate thick portion 11 is set to w1. To a TFT-substrate thin portion 12 surrounded by the TFT-substrate thick portion 11, a lower polarizer 15 is adhered. A thickness of the lower polarizer 15 is set to 0.12 mm, for example. In FIG. 1B, a thickness of the TFT-substrate thick portion 11 is set to 0.22 mm, for example, and a thickness of the TFT-substrate thin portion 12 is set to 0.1 mm. Accordingly, a lower surface of the TFT-substrate thick portion 11 and a lower surface of the lower polarizer 15 have the same height.

In FIG. 1B, although the lower polarizer 15 is adhered to a recessed portion of the TFT substrate 10, a profile of the lower polarizer 15 is smaller than an inner size of the recessed portion which constitutes a thin portion of the TFT substrate 10. The thick portion and the thin portion of the TFT substrate 10 are connected with each other by a gentle curve, and an edge portion of the lower polarizer 15 corresponds to a portion of the TFT substrate 10 which is positioned more inwardly than a portion of the TFT substrate 10 by a distance “d” where a curved portion of the TFT substrate 10 terminates and a flat portion of the TFT substrate 10 starts. A value of “d” is set to 0.1 mm, for example.

By setting the profile of the polarizer 15 smaller than the inner size of the recessed portion of the TFT substrate 10 by a predetermined value in this manner, it is possible to surely allow the surface of the TFT-substrate thick portion 11 and the surface of the lower polarizer 15 to have the same height. Although only the constitution of the TFT-substrate-10 side has been explained in conjunction with FIG. 1B, the relationship between the profile of the upper polarizer 25 and the inner size of the recessed portion of the counter substrate 20 is substantially equal to the relationship explained with respect to the TFT substrate 10.

In FIG. 1B, on a portion of the TFT substrate 10 on a side opposite to the terminal portion 40, a thick portion is formed. The counter substrate 20 is not adhered to the terminal portion 40 of the TFT substrate 10. Accordingly, to allow the terminal portion 40 to ensure strength, the thick portion is formed on the TFT substrate 10 on the side opposite to the terminal portion 40. A width of the thick portion of the terminal portion 40 is set to w2.

In FIG. 1B, edge portions 13 which correspond to a scribe portion for separating this liquid crystal cell 1 from the other liquid crystal cell 1 are not formed into a sharp edge but are rounded. Further, distal edge portions of the thick portions in FIG. 1B are not scribed and hence, minute cracks caused by scribing do not occur. The edge portions 13 do not form a sharp edge but form a round edge and hence, the minute cracks caused by an impact or the like from the outside scarcely occur. When the minute cracks scarcely occur, the breaking of the TFT substrate 10 or the counter substrate 20 caused by the minute cracks scarcely occurs. The edge portion 13 which is rounded as described above is formed by decreasing a thickness of the edge portion 13 at a scribing region 50 by chemical polishing as explained later.

FIG. 1C is a cross-sectional view of the liquid crystal display device taken along a line A-A in FIG. 1A. In FIG. 1C, in the same manner as the constitution shown in FIG. 1B, the recessed portion is formed on the TFT substrate 10 and the counter substrate 20 respectively, and the lower polarizer 15 and the upper polarizer 25 are adhered to the recessed portions respectively. A thickness of the thick portion of the counter substrate 20 is set to t1, and a thickness of a thin portion of the counter substrate 20 is set to t3. Further, a thickness of the upper polarizer 25 is set to (t1-t3) which is a value obtained by subtracting the thickness t3 from the thickness t1. With respect to the TFT substrate 10 shown in FIG. 1C, a thickness of the thick portion is set to t2, and a thickness of the thin portion is set to t4. Here, a thickness of the lower polarizer 15 is set to (t2-t4) which is a value obtained by subtracting the thickness t4 from the thickness t2.

In the above-mentioned example, the plate thickness t2 of the thick portion of the TFT substrate 10 and the plate thickness t1 of the thick portion of the counter substrate 20 are set equal, and the plate thickness t4 of the thin portion of the TFT substrate 10 and the plate thickness t3 of the thin portion of the counter substrate 20 are set equal. However, it is not always necessary to set the thickness t1 and the thickness t2 equal and to set the thickness t3 and the thickness t4 equal. That is, the plate thickness of the TFT substrate 10 and the plate thickness of the counter substrate 20 may differ from each other. The gist of the present invention lies in that both the peripheral portion of the TFT substrate 10 and the peripheral portion of the counter substrate 20 have the large thickness, and the thick portion is not formed on the terminal-portion-40 side of the counter substrate 20.

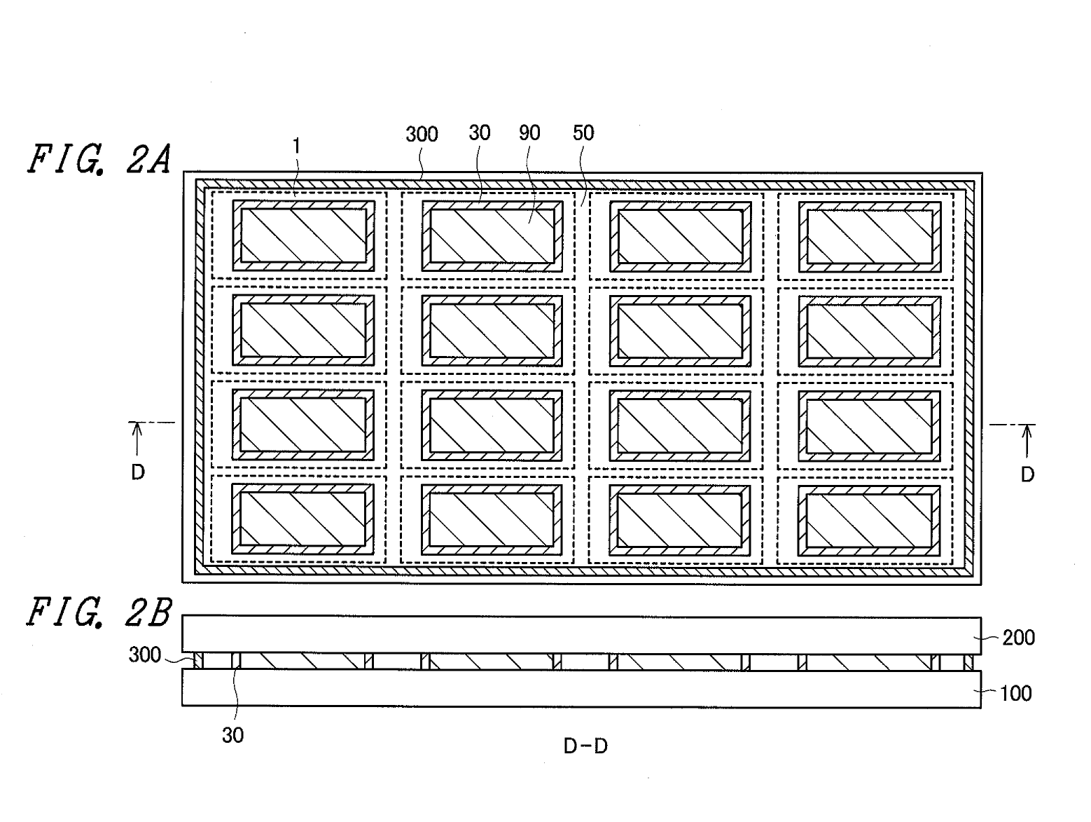

FIG. 2A and FIG. 2B are views showing a state of a mother substrate before the mother substrate is divided into the liquid crystal cells 1 shown in FIG. 1. In FIG. 2, sixteen (4×4=16) liquid crystal cells 1 are formed on the mother substrate. In FIG. 2A, portions along which individual liquid crystal cells 1 are separated from the mother substrate are indicated by a dotted line. Here, in the individual liquid crystal cell 1, a portion of the mother substrate for forming the counter substrate 20 is also indicated by the dotted line.

Both a mother TFT substrate 100 and a mother counter substrate 200 which constitute the mother substrate have a thickness of 0.4 mm before polishing is applied to the respective substrates 100 and 200. The thicknesses of the respective substrates 100, 200 are decreased to approximately 0.22 mm by mechanical polishing or chemical polishing. Although both mechanical polishing and chemical polishing use a polishing liquid, for preventing the intrusion of the polishing liquid into the inside of the mother substrate, the inside of the mother substrate is sealed with a mother substrate sealing material 300 which is formed on a periphery of the mother substrate.

Further, the sealing material 30 is also provided to the individual liquid crystal cell 1 so that liquid crystal is filled in the individual liquid crystal cell 1 and is sealed with the sealing material 30. In FIG. 2A, liquid crystal is filled in the liquid crystal cell 1 inside the sealing material 30 by a dropping method and hence, the individual liquid crystal cell 1 is not provided with a liquid crystal filling port for filling liquid crystal. As explained later, the present invention is also applicable to a liquid crystal display device of a type which is manufactured by filling liquid crystal in the individual liquid crystal cell 1 through a filling port.

In FIG. 2, initial thicknesses of the mother TFT substrate 100 and the mother counter substrate 200 of the mother substrate are set to 0.4 mm. From such a state, the thicknesses of the mother TFT substrate 100 and the mother counter substrate 200 are decreased to 0.22 mm respectively by mechanical polishing or chemical polishing.

Thereafter, chemical polishing is applied to the mother substrate in a state that a mask 60 covers only portions of the mother substrate which will become the thick portion of the counter substrates 20 and the thick portion of the TFT substrate 10 shown in FIG. 1. As a result, only the portions which are covered with the mask 60 are not polished by the chemical polishing and hence, these portions maintain the thickness of 0.22 mm, and thicknesses of other portions which are not covered with the mask 60 are decreased to approximately 0.1 mm by chemical polishing.

In FIG. 2A, the scribing regions 50 each of which is defined between the individual liquid crystal cells 1 are also not covered with the mask 60 and hence, the thickness of the scribing regions 50 is also decreased by chemical polishing. The scribing regions 50 are polished by chemical polishing and hence, the scribing regions 50 do not form a sharp edge but are rounded. Accordingly, in scribing the mother substrate for dividing the mother substrate into the individual liquid crystal cells 1 after chemical polishing, the minute cracks scarcely occur in the edge portions 13 which constitute the peripheral thick portions and are rounded by chemical polishing. Further, the edge portions 13 are rounded and hence, it is possible to prevent the occurrence of cracks caused by an impact from the outside.

FIG. 2B is a cross-sectional view of the mother substrate taken along a line D-D in FIG. 2A. In FIG. 2B, the plate thickness of the mother TFT substrate 100 and the plate thickness of the mother counter substrate 200 are decreased to 0.22 mm by mechanical polishing or chemical polishing. The mother sealing material 300 is formed on the periphery of the mother TFT substrate 100 and the periphery of the mother counter substrate 200 thus sealing the inside of the mother substrate. Further, with respect to the individual liquid crystal cells 1, the inside of each liquid crystal cell 1 is sealed with the sealing material 30, and is filled with liquid crystal.

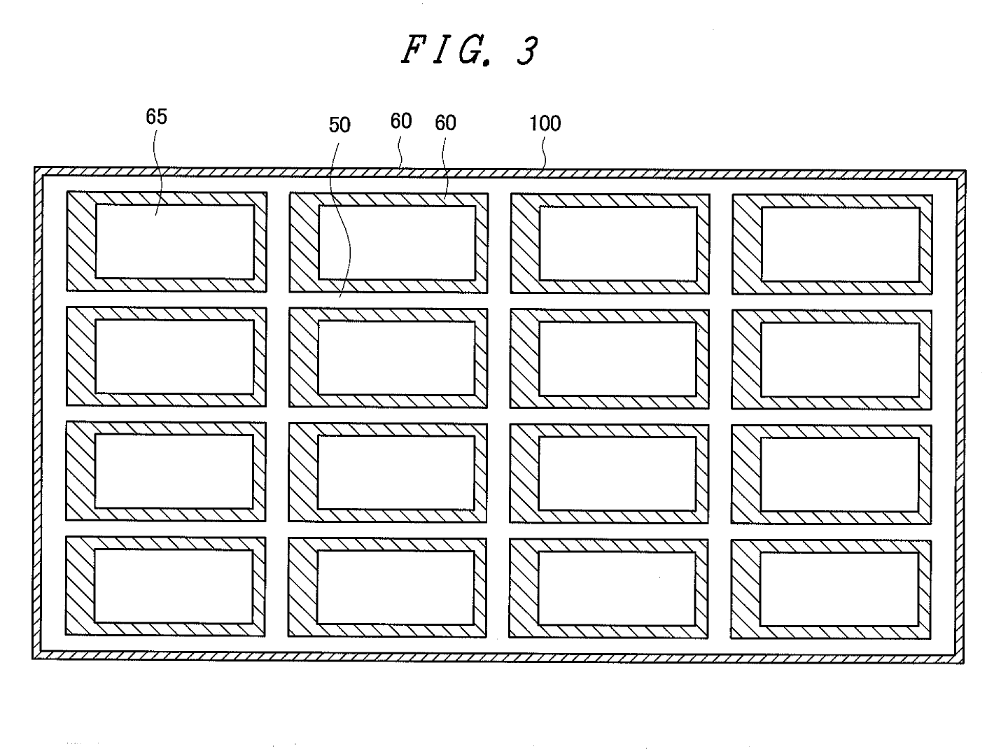

FIG. 3 is view showing a shape of the mask 60 used for forming the portion having a large plate thickness and the portion having a small plate thickness on the TFT substrate 10 of each individual liquid crystal cell 1 by applying chemical polishing to the mother TFT substrate 100 shown in FIG. 2. The mask 60 shown in FIG. 3 is adhered to portions of the mother substrate corresponding to a back side of the respective TFT substrates 10 shown in FIG. 1. In FIG. 3, window portions 65 to which the mask 60 is not adhered corresponds to portions of the TFT substrates 10 to which the lower polarizer 15 is adhered.

The mask 60 is adhered to the mother TFT substrate 100 corresponding to the individual liquid crystal cells 1. In FIG. 3, portions to which hatching is applied correspond to the portions to which the mask 60 is adhered. Further, the mask 60 is adhered also to the periphery of the mother TFT substrate 100 thus maintaining the large plate thickness of the periphery of the mother TFT substrate 100 even after the chemical polishing is applied to the mother TFT substrate 100. This structure is adopted for ensuring strength of the mother TFT substrate 100 as a whole.

In FIG. 3, the mask 60 is not adhered to the boundaries between the individual liquid crystal cells 1, that is, to the scribing regions 50. Accordingly, the plate thickness of the scribing regions 50 is decreased by chemical polishing and, at the same time, due to the chemical polishing, the formation of the sharp edge is eliminated so that the scribing regions 50 are rounded as shown in FIG. 1 thus increasing the mechanical stability of the mother TFT substrate 100.

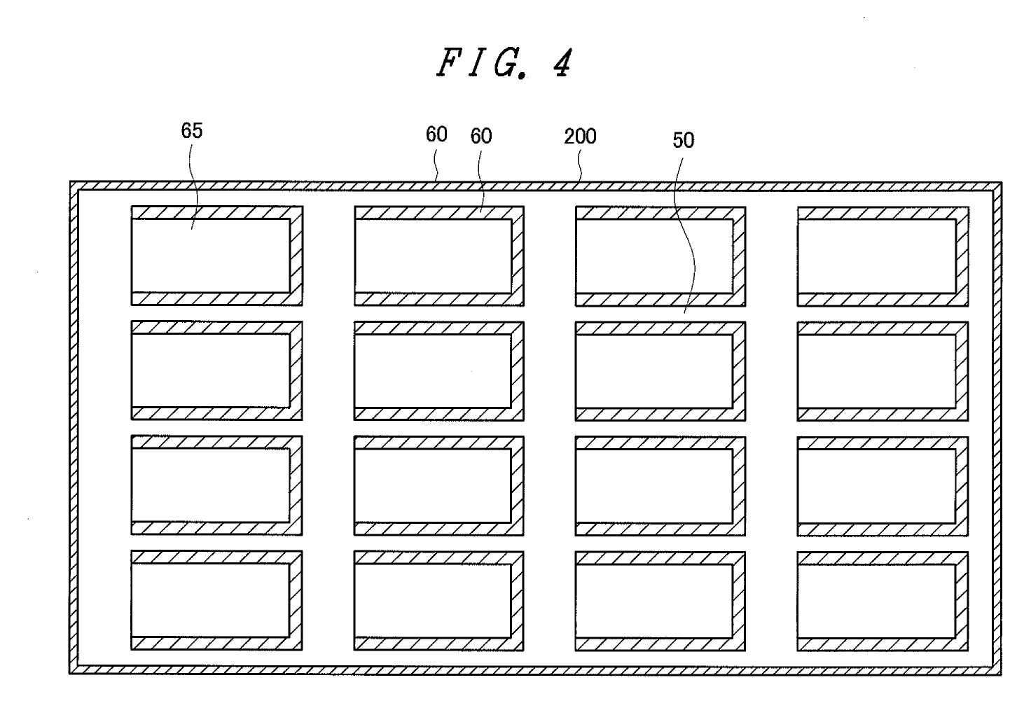

FIG. 4 is a view showing a shape of a mask 60 used for forming the portion having a large plate thickness and the portion having a small plate thickness on the counter substrate 20 of each liquid crystal cell 1 by applying chemical polishing to the mother counter substrate 200 shown in FIG. 2. The mask 60 shown in FIG. 4 is adhered to portions of the mother counter substrate 200 corresponding to a front side of the respective counter substrates 20 shown in FIG. 1.

In FIG. 4, the mask 60 for forming individual counter substrate 20 has a U shape. With respect to the mask 60 corresponding to the individual counter substrate 20, an opening-portion side of the U shape corresponds to a terminal side of the TFT substrate 10. A portion of the counter substrate 20 to which the mask 60 is adhered corresponds to the portion of the counter substrate 20 having a large plate thickness in FIG. 1. Further, the window portion 65 which is surrounded by the U-shaped mask 60 corresponds to the portion of the counter substrate 20 to which the upper polarizer 25 is adhered. In the same manner as the mother TFT substrate 100, the mask 60 is also adhered to the periphery of the mother counter substrate 200. Accordingly, the periphery of the mother counter substrate 200 can maintain a large thickness thus allowing the mother counter substrate 200 to ensure strength thereof as a whole.

In FIG. 4, the mask is not adhered to the boundaries between the individual liquid crystal cells 1, that is, to the scribing regions 50. Accordingly, the plate thickness of the scribing regions 50 is decreased by chemical polishing and, at the same time, due to the chemical polishing, the formation of the sharp edge is eliminated so that the scribing regions 50 are rounded as shown in FIG. 1 thus increasing the mechanical stability of the mother counter substrate 200 in the same manner as the mother TFT substrate 100.

When the whole mother substrate is polished by chemical polishing using the mask 60 shown in FIG. 3 and FIG. 4, only portions shown in FIG. 3 and FIG. 4 which are covered with the mask 60 remain with a large thickness, and other portions which are not covered with the mask 60 are polished by chemical polishing so that the thicknesses of other portions of both the mother counter substrate 200 and the mother TFT substrate 100 are decreased to approximately 0.1 mm. Here, the scribing regions 50 for dividing the mother substrate into the individual liquid crystal cells 1 are polished by chemical polishing so that the thickness of the scribe portions 50 is decreased. Accordingly, the scribing can be easily performed.

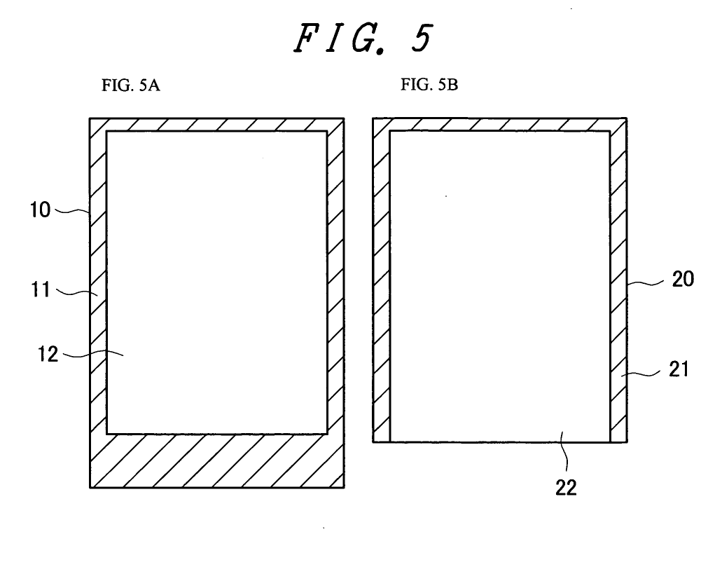

FIG. 5A and FIG. 5B are plan views of the TFT substrate 10 and the counter substrate 20 of the individual liquid crystal cell 1 after the mother substrate is polished by chemical polishing in the above-mentioned manner respectively. FIG. 5A is a plan view of the TFT substrate 10 as viewed from a back side of the TFT substrate 10. In FIG. 5A, a hatched portion corresponds to the portion of the TFT substrate 10 having a large thickness, and an inner region surrounded by the hatched portion corresponds to the portion of the TFT substrate 10 whose plate thickness is decreased by chemical polishing.

FIG. 5B is a plan view of the counter substrate 20 as viewed from a front side of the counter substrate 20. In FIG. 5B, a hatched portion corresponds to the portion of the counter substrate 20 having a large plate thickness, and an inner region surrounded by the hatched portion corresponds to the portion of the counter substrate 20 whose plate thickness is decreased by chemical polishing. In FIG. 5B, the portion having a large plate thickness has a U shape. A portion of the counter substrate 20 on a side where the counter substrate 20 does not have a large plate thickness constitutes a terminal side.

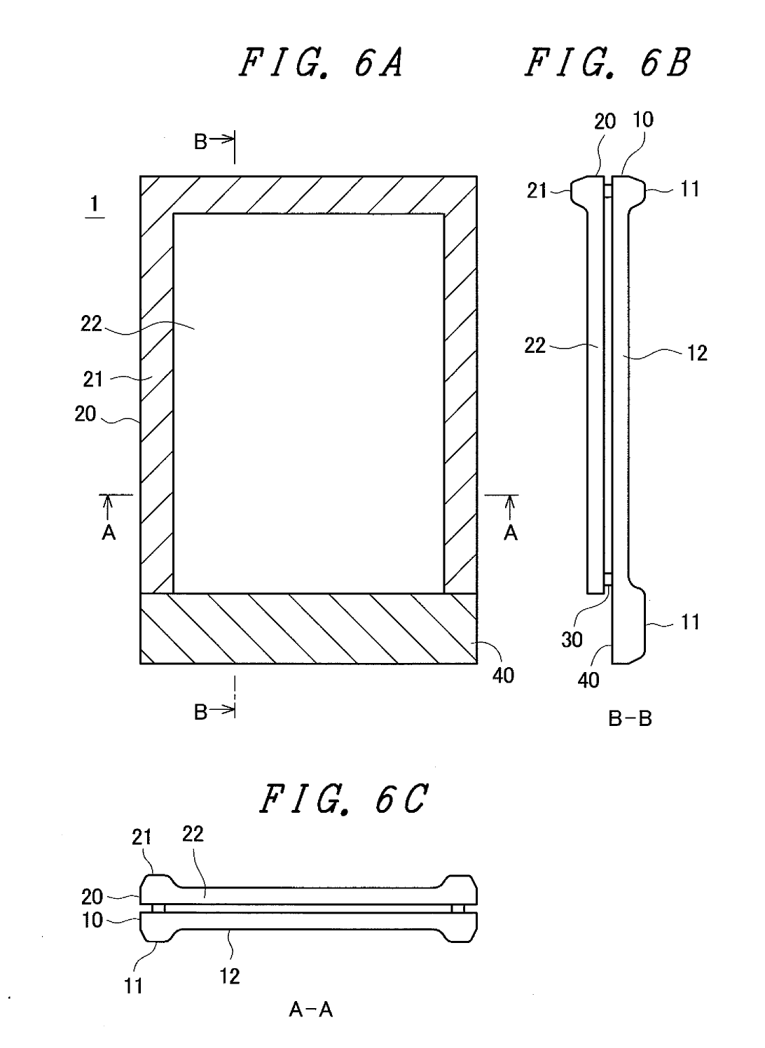

FIG. 6A to FIG. 6C are views showing a state where the counter substrate 20 and the TFT substrate 10 shown in FIG. 5 overlap each other, and the mother substrate is divided into the individual liquid crystal cells 1 by scribing. FIG. 6A is a plan view showing a state where the counter substrate 20 and the TFT substrate 10 overlap each other. In this state, the upper polarizer 25 is not yet adhered to the counter substrate 20. The constitution shown in FIG. 6A is substantially equal to the constitution shown in FIG. 1A except for that the polarizer is not adhered to the counter substrate 20 and the TFT substrate 10 respectively.

FIG. 6B is a cross-sectional view taken along a line B-B in FIG. 6A. In FIG. 6B, the liquid crystal layer 150 is sandwiched between the counter substrate 20 and the TFT substrate 10. Further, in FIG. 6B, the scribing regions 50 are rounded and have a shape which imparts a strong resistance to the counter substrate 20 and the TFT substrate 10 against an impact from the outside. The constitution shown in FIG. 6B is substantially equal to the constitution shown in FIG. 1B except that the polarizer is adhered neither to the counter substrate 20 nor the TFT substrate 10.

FIG. 6C is a cross-sectional view taken along a line A-A in FIG. 6A. In FIG. 6C, the liquid crystal layer 150 is sandwiched between the counter substrate 20 and the TFT substrate 10. In FIG. 6C, the scribing regions 50 are rounded and have a shape which imparts a strong resistance to the counter substrate 20 and the TFT substrate 10 against an impact from the outside. The constitution shown in FIG. 6C is substantially equal to the constitution shown in FIG. 1C except that the polarizer is adhered neither to the counter substrate 20 nor the TFT substrate 10.

By adhering the upper polarizer 25 to the recessed portion of the counter substrate 20 and by adhering the lower polarizer 15 to the recessed portion of the TFT substrate 10 in the liquid crystal cell 1 assembled as shown in FIG. 6, it is possible to manufacture a liquid crystal display device substantially equal to the liquid crystal display device shown in FIG. 1.

The explanation has been made heretofore with respect to the example where the liquid crystal cell 1 formed on the mother substrate is, as shown in FIG. 2, filled with liquid crystal by a dropping method. The present invention is applicable not only to the liquid crystal display device of a type in which liquid crystal is filled into the liquid crystal cell by a dropping method but also to a liquid crystal display device of a type in which liquid crystal is filled into a liquid crystal cell through a filling port.

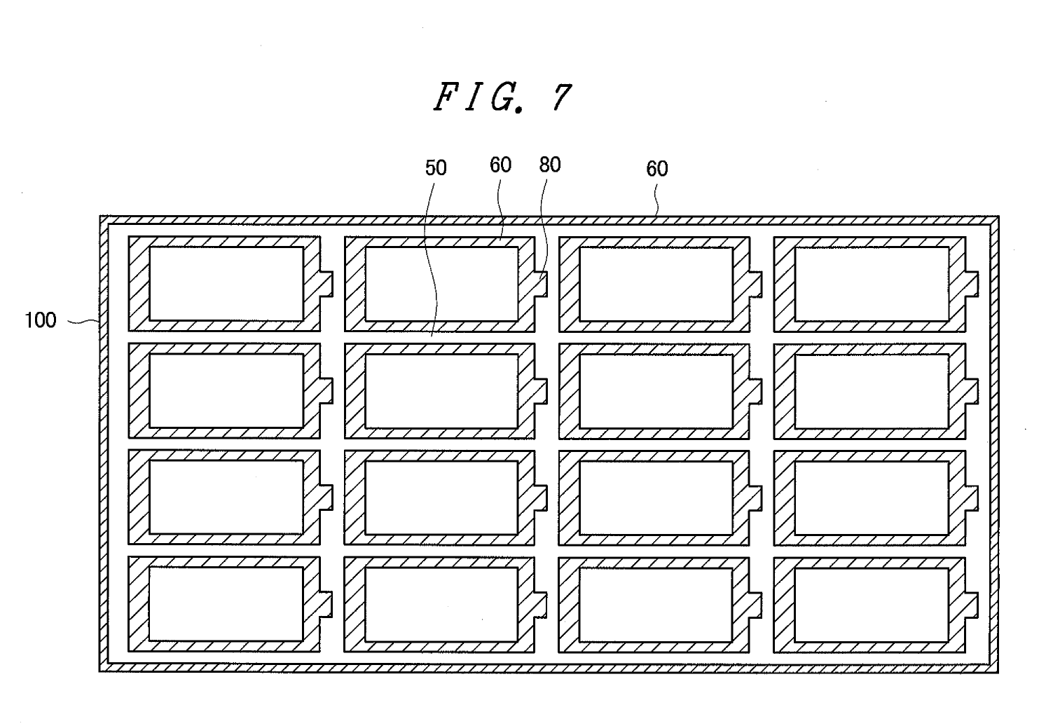

FIG. 7 shows an example in which the present invention is applied to a liquid crystal cell 1 of a type into which liquid crystal is filled in the liquid crystal cell 1 by a sealing method. FIG. 7 is a plan view showing a state in which a mask 60 is adhered to a back side of a mother TFT substrate 100 of a mother substrate corresponding to individual liquid crystal cells 1.

In FIG. 7, not only portions of the mother TFT substrate 100 corresponding to peripheries and terminal portions 40 of the individual liquid crystal cells 1 but also portions of the mother TFT substrate 100 corresponding to filling-port forming portions 80 of the individual liquid crystal cells 1 through which liquid crystal is filled in the liquid crystal cells 1 are covered with a mask 60 for avoiding chemical polishing thus allowing these portions to maintain a large plate thickness. Further, by covering a periphery of the mother substrate with the mask 60, the mother substrate can maintain a large plate thickness and hence, the mother substrate can ensure a sufficient strength as a whole.

In FIG. 7, liquid crystal is not yet filled into the individual liquid crystal cells 1. This is because that, when the sealing method is adopted, it is difficult to fill liquid crystal into the liquid crystal cell 1 through the filling port unless the mother substrate is divided into the respective liquid crystal cells 1. In the constitution shown in FIG. 7, the intrusion of a polishing liquid into the inside of the individual liquid crystal cells 1 is prevented by sealing the periphery of the mother substrate using a mother substrate sealing material 300.

Although the mother counter substrate 200 of this embodiment is not shown in the drawing, in the same manner as the mother TFT substrate 100, a mask 60 is formed portions of the mother counter substrate 200 corresponding to liquid-crystal suction portions of the individual crystal cells 1 thus allowing these portions to maintain a large plate thickness. Thereafter, the mother substrate is chemically polished thus forming the portion where the large thickness remains and the thin portion in the TFT substrate 10 and the counter substrate 20. Then, the mother substrate is divided into the individual liquid crystal cells 1 along the scribing regions 50. Liquid crystal is filled in the liquid crystal cell 1 for every divided individual liquid crystal cell 1 through the liquid crystal filling port.

### Embodiment 2

In the explanation of the embodiment 1, the explanation has been made with respect to the method in which the thick portion and the thin portion are formed on the TFT substrate 10 and the counter substrate 20 of the individual liquid crystal cell 1 respectively in the step of polishing the mother substrate. In the embodiment 1, the adhesion of the mask 60 becomes necessary for every individual liquid crystal cell 1. That is, for example, as shown in FIG. 3, when 16 pieces of TFT substrates 10 are formed on the mother TFT substrate 100, 16 pieces of masks 60 become necessary. Accordingly, 16 pieces of masks 60 are adhered for every one mother TFT substrate 100. Further, 16 pieces of masks 60 are adhered for every one mother counter substrate 200. As described above, there exists a possibility that the adhesion of a large number of masks 60 to the mother substrate lowers a throughput.

This embodiment provides a method in which a portion having a large thickness and a portion having a small thickness are formed for every individual liquid crystal cell 1 in the same manner as the embodiment 1 using a meshed mask. By using the meshed mask, masks which correspond to the individual liquid crystal cells 1 respectively can be formed on a single sheet of mask. That is, it is sufficient to provide one sheet of mask 60 to the mother TFT substrate 100 and the mother counter substrate 200 respectively.

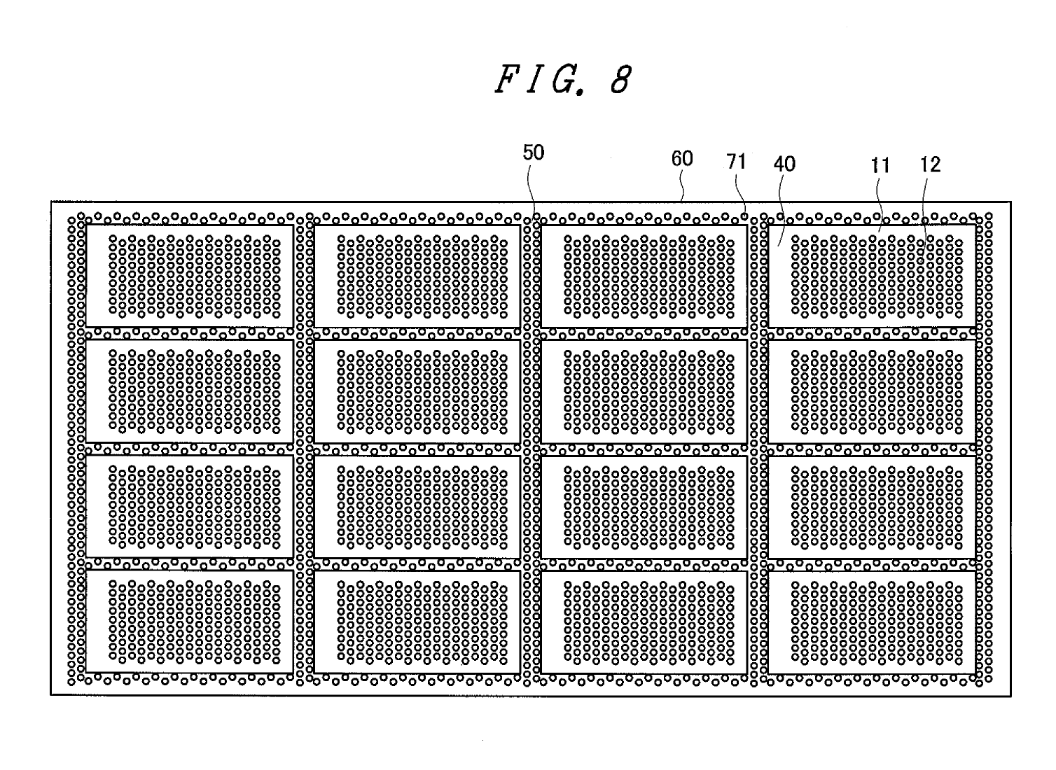

FIG. 8 shows an example of the mask 60 which corresponds to the mother TFT substrate 100 used in this embodiment. In FIG. 8, portions of the mask 60 where a large number of small holes 71 are formed correspond to portions of the mother TFT substrate 100 whose plate thickness is to be decreased, and portions of the mask 60 where the holes 71 are not formed correspond to portions of the mother TFT substrate 100 whose large plate thickness is to be maintained.

That is, at the portions of the mask 60 where a large number of small holes 71 are formed, a chemical polishing liquid passes through the holes 71 and etches a glass substrate. The polishing liquid performs etching of the glass substrate not only in the thickness direction of the glass substrate but also in the sideward direction of the glass substrate. Due to such etching, portions of the glass substrate corresponding to the portions of the mask 60 where the holes 71 are not formed are also etched by the polishing liquid coupled with the side etching from the holes 71 arranged in the periphery of the portions. Accordingly, by suitably setting a size and arrangement pitches of the holes 71, the portions of the glass substrate corresponding to the portions of the mask 60 where the holes 71 are formed in a meshed shape are chemically polished substantially uniformly in the thickness direction.

In FIG. 8, the portions of the mask 60 where the holes 71 are formed in a meshed shape are portions each of which corresponds to a portion of each TFT substrate 10 to which the lower polarizer is adhered and the scribing regions 50. On the other hand, the holes 71 in a meshed shape are not formed in the portions of the mask 60 corresponding to a thick portion and a terminal portion 40 of each TFT substrate 10 and hence, the portions are not polished by chemical polishing.

Although the chemical polishing of the mother TFT substrate 100 has been explained heretofore, the chemical polishing of the mother counter substrate 200 is performed in the substantially same manner as the mother TFT substrate 100. In this manner, according to this embodiment, with the use of the mask 60 in a meshed shape which forms the holes 71 having a predetermined size therein at predetermined pitches in the portions thereof which require chemical polishing, the required chemical polishing can be performed using one sheet of mask 60 per one mother TFT substrate 100 or per one mother counter substrate 200. Accordingly, the throughput of the chemical polishing per one mother substrate can be increased.

### Embodiment 3

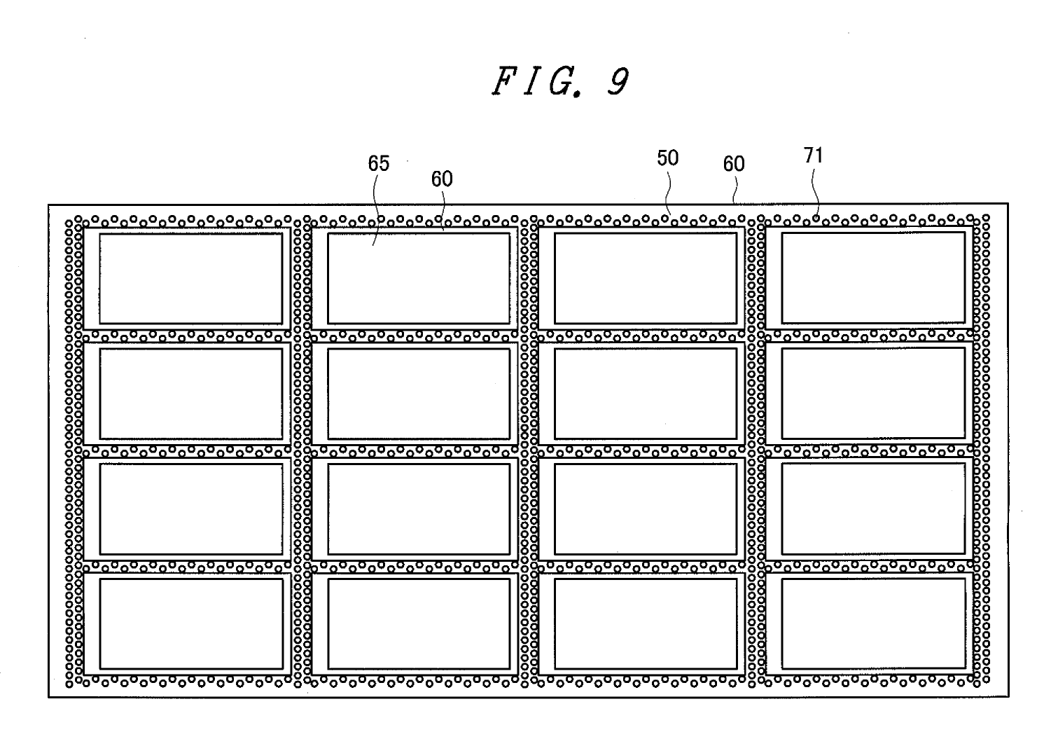

FIG. 9 shows an example of a mask 60 for applying chemical polishing to a mother TFT substrate 100 in the embodiment 3 of the present invention. In FIG. 9, different from the embodiment 2, on portions of the mask 60 corresponding to portions of TFT substrates 10 to which an upper polarizer 25 is adhered, a window portion 65 is formed. On the other hand, in the same manner as the scribing regions 50 in the second embodiment, a large number of holes 71 are formed in portions of the mask 60 corresponding to the scribing regions 50.

In the embodiment 2, with respect to the TFT substrate 10, the portion of the TFT substrate 10 to which the upper polarizer 25 is adhered is also polished by chemical polishing using the mask 60 in a meshed shape where a large number of holes 71 are formed. When the chemical polishing is performed through the small holes 71, there may be a case where the portion of the TFT substrate 10 corresponding to the hole 71 is deeply etched, and the portion of the TFT substrate 10 corresponding to the portion of the mask 60 between the holes 71 is shallowly etched. In such a case, surface irregularities corresponding to the arrangement pitches of the holes 71 formed in the mask 60 are generated on the portion of the TFT substrate 10 which corresponds to a display region 90 thus giving rise to a possibility that quality of an image is deteriorated.

According to the embodiment shown in FIG. 9, a complete window portion 65 is formed on the portions of the mask each of which corresponds to the display region 90 to which the upper polarizer 25 is adhered. Due to such a constitution, the surface irregularities which may be generated in the above-mentioned embodiment 2 are not generated. Accordingly, the display region 90 can always have a flat surface and hence, there is no possibility that quality an image is deteriorated.

In FIG. 9, a large number of holes 71 are formed in the portions of the mask corresponding to the scribing regions 50, and the scribing regions 50 are polished through the holes 71. The scribing regions 50 are polished through the holes 71 and hence, there exists a possibility that surface irregularities remain on the scribing region 50. However, the scribing regions 50 are irrelevant to quality of an image and hence, there arises no significant problem.

On the other hand, although a large number of holes 71 are formed in portions of the mask 60 corresponding to the scribing regions 50, these holes 71 are continuously and integrally formed in the mask 60 and hence, it is sufficient to provide one sheet of mask as the mask 60 to be adhered to the mother TFT substrate 100. In this manner, it is sufficient to provide one sheet of mask as the mask 60 to be adhered to the mother TFT substrate 100 and hence, the throughput of the adhesion of the mask 60 can be enhanced.

In the explanation made heretofore, although the relationship between the mother TFT substrate 100 and the mask 60 is explained, the relationship between the mother counter substrate 200 and a mask 60 is substantially equal to the relationship between the mother TFT substrate 100 and the mask 60. That is, according to this embodiment, both mother TFT substrate 100 and mother counter substrate 200 can be etched respectively by chemical etching using one sheet of mask 60.

What is claimed is:

1. A display device comprising:
a TFT substrate on which pixels each of which includes a pixel electrode and a thin film transistor are formed in a matrix array;
a counter substrate which is arranged to face the TFT substrate in an opposed manner with a predetermined distance defined therebetween; and
liquid crystal which is sandwiched between the TFT substrate and the counter substrate,
the TFT substrate being formed larger than counter substrate in size, and a terminal portion being formed on a portion of the TFT substrate where the TFT substrate is formed larger than the counter substrate, wherein
a periphery of the counter substrate is formed of three sides having a large thickness and one side having a thickness smaller than the thickness of said three sides, said one side corresponding to the terminal portion formed on the TFT substrate,
a periphery of the TFT substrate is formed of four sides having a large thickness and one of said four sides corresponds to the terminal portion, and
edge portions of the TFT substrate and edge portions of the counter substrate are polished by chemical polishing.

2. A method of manufacturing a liquid crystal display device in which a liquid crystal display device are manufactured by dividing a mother substrate which is constituted of a mother TFT substrate on which a plurality of TFT substrates are formed and a mother counter substrate on which a plurality of counter substrates are formed into individual liquid crystal cells, wherein
a TFT substrate mask having a window is adhered to the mother TFT substrate for every TFT substrate, and a space is defined between the TFT substrate mask and the TFT substrate mask,
a counter substrate mask having a window is adhered to the mother counter substrate for every counter substrate, and a space is defined between the counter substrate mask and the counter substrate mask,
the TFT substrate masks are adhered to the mother TFT substrate, and the counter substrate masks are adhered to the mother counter substrate, and
portions of the mother TFT substrate and portions of the mother counter substrate which are not covered with the TFT substrate mask and the counter substrate mask are polished by chemical polishing.

3. A method of manufacturing a liquid crystal display device in which a liquid crystal display device are manufactured by dividing a mother substrate which is constituted of a mother TFT substrate on which a plurality of TFT substrates are formed and a mother counter substrate on which a plurality of counter substrates are formed into individual liquid crystal cells, wherein
a mother TFT substrate mask on which a first region and a second region are formed is adhered to the mother TFT substrate for every said TFT substrate in a state where the first region includes a center portion having a plurality of holes in a predetermined area and a peripheral portion having no holes, and a plurality of holes are formed in the second region between the first region corresponding to the TFT substrate and the first region corresponding to the TFT substrate,
a mother counter substrate mask on which a third region and a fourth region are formed is adhered to the mother counter substrate for every counter substrate in a state where the third region includes a center portion having a plurality of holes in a predetermined area and a peripheral portion having no holes, and a plurality of holes are formed in the fourth region between the third region corresponding to the counter substrate and the third region corresponding to the counter substrate, and
the portions of the mother TFT substrate corresponding to the portions of the mother TFT substrate mask where the plurality of holes are formed and the portions of the mother counter substrate corresponding to the portions of the mother counter substrate mask, where the plurality of holes are formed are polished by chemical polishing of the mother substrate.

4. A method of manufacturing a liquid crystal display device in which a liquid crystal display device are manufactured by dividing a mother substrate which is constituted of a mother TFT substrate on which a plurality of TFT substrates are formed and a mother counter substrate on which a plurality of counter substrates are formed into individual liquid crystal cells, wherein
a mother TFT substrate mask on which a first region and a second region are formed is adhered to the mother TFT substrate for every TFT substrate in a state where the first region includes a window portion having a predetermined area and a peripheral portion around the window portion, and a plurality of holes are formed in the second region between the first region corresponding to the TFT substrate and the first region corresponding to the TFT substrate,
a mother counter substrate mask on which a third region and a fourth region are formed is adhered to the mother counter substrate for every counter substrate in a state where the third region includes a window portion having a predetermined area and a peripheral portion around the window portion, and a plurality of holes are formed in the fourth region between the third region corresponding to the counter substrate and the third region corresponding to the counter substrate, and
the portions of the mother TFT substrate corresponding to the portions of the mother TFT substrate mask where the window portions and the plurality of holes are formed and the portions of the mother counter substrate corresponding to the portions of the mother counter substrate mask where the window portions and the plurality of holes are formed are polished by chemical polishing of the mother substrate.
